(19) United States
(12) Patent Application Publication
(10) Pub. No.: US 2015/0312240 A1
(43) Pub. Date: Oct. 29, 2015

(54) WIRELESS AUTOMATIC PAIRING METHOD, METHOD OF ESTABLISHING CONNECTION, AND WIRELESS ACCESS POINT DEVICE

(71) Applicant: ALTEK CORPORATION, Hsinchu (TW)

(72) Inventor: Yen-Sheng FU, Taoyuan County (TW)

(21) Appl. No.: 14/309,184

(22) Filed: Jun. 19, 2014

(30) Foreign Application Priority Data
Apr. 29, 2014 (TW) 103115240
May 7, 2014 (TW) 103116174

(51) Int. Cl. H04L 29/06; H04W 76/02; H04W 4/00; H04W 12/06; H04W 12/08

(52) U.S. Cl. CPC H04L 63/083; H04W 12/06; H04W 12/08; H04W 4/008; H04W 76/02

(57) ABSTRACT

The present disclosure illustrates a wireless automatic pairing method, a method of establishing connection, and a wireless access point device which enable an electronic device to connect with a wireless access point device by automatic pairing. The method of establishing connection comprises steps of: establishing a connection from the electronic device to the wireless access point device; transmitting the network identification code from the electronic device to the wireless access point device; in the electronic device, receiving a network name and a password transmitted from the wireless access point device; terminating the connection between the wireless access point device and the electronic device; transmitting a connection request containing the network identification code, the network name, and the password to the wireless access point device; establishing a connection between the electronic device and the wireless access point device.

### CROSS-REFERENCE TO RELATED APPLICATION

This application claims the benefit of Taiwan Patent Application No. 103115240, filed on Apr. 29, 2014, in the Taiwan Intellectual Property Office, the disclosure of which is incorporated herein in its entirety by reference.

This application claims the benefit of Taiwan Patent Application No. 103116174, filed on May 7, 2014, in the Taiwan Intellectual Property Office, the disclosure of which is incorporated herein in its entirety by reference.

### BACKGROUND OF THE INVENTION

1. Field of the Invention

The present disclosure relates to a connection pairing method, in particular, to a wireless automatic pairing method capable of improving both of security and convenience of connection.

2. Description of the Related Art

In general, a family or a company builds a wireless network environment by an access point, router, or modem. The access point or the router are connected to internet service provider via the cable and the modem, so the user just needs a cell phone or a computer having wireless network card module for connecting to the access point or the router by Wi-Fi, to establish the connection between the cell phone or computer and access point or router.

There are two ways for connection with the access point or the router by Wi-Fi, a first way is an open mode and a second way is an encryption mode. In the first way, the connection with the access point or the router can be established via the Wi-Fi without inputting one-time password, so it is very convenient for the user, but the packets of transmitted data may be snooped possibly in the first way. In the second way, the first connection with the access point or the router via Wi-Fi needs manual input of one-time password in the first verification, so it has excessive security for data transmission but is inconvenient for user operation.

Therefore, the inventor of the present disclosure designs a wireless automatic pairing method, a method of establishing connection and a wireless access point device to solve the problems of these two traditional connection ways, and improve the industrial applicability.

### SUMMARY OF THE INVENTION

To solve the above-mentioned problem, an aspect of exemplary embodiments of the present disclosure directs to a wireless automatic pairing method, a method of establishing connection and a wireless access point device which provide the user to input one-time password without manual operation, so an electronic device can be connected to a wireless access point device by an encryption mode, and both convenience of user operation and security of data transmission are improved.

An aspect of exemplary embodiments of the present disclosure directs to a wireless automatic pairing method, a method of establishing connection and a wireless access point device which can establish a securer automatic pairing by a connection service program and a connection establishing program.

An aspect of exemplary embodiments of the present disclosure directs to a method of establishing connection and a wireless access point device using the same method, which can establish a securer connection by a connection service program of the electronic device and a service program of the wireless access point device.

An exemplary embodiment of the present disclosure provides a wireless automatic pairing method, adapted for a wireless connection between an electronic device and a wireless access point device, the method comprises steps of: executing an connection establishing program on the electronic device to connect with the wireless access point device; transmitting a network identification code of the electronic device to the connection service program of the wireless access point device, and generating a copy of the network identification code; using the connection service program of the wireless access point device to generate and transmit a network name and a password to the connection establishing program, or using the electronic device to detect a recognition pattern for obtaining the network name and the password, the recognition pattern being generated by the connection service program; terminating the connection between the wireless access point device and the electronic device; using the connection establishing program to transmit a connection request to the connection service program, connection request containing the network name and the password; determining whether the network identification code, the network name, the password is correct or not; wherein when the connection request comprises the network name and the password, and the network identification code is equal to the copy of the network identification code, the connection service program permits the connection establishing program to establish the connection between the wireless access point device and the electronic device.

Preferably, the wireless access point device is preset in an open mode, after the connection service program transmits the network name and the password to the connection establishing program, the connection service program sets the wireless access point device in an encryption mode.

Preferably, the recognition pattern is displayed on a display interface of the wireless access point, and the electronic device detects the display interface of the recognition pattern to obtain the network name and the password.

Preferably, the recognition pattern includes a QR code or a preset encoded picture.

Preferably, the recognition pattern further comprises a company name or a security type.

Preferably, the method further comprises a step of using the connection establishing program to connect with the wireless access point device while the electronic device and the wireless access point device are connected, to enable the wireless access point device to generate the network name and the password. The position of the password in the recognition pattern is determined while the connection establishing program is connected with the wireless access point device.

Preferably, the wireless access point device comprises a cell phone, a camera, a laptop computer, a game player, a printer or a music player which have network transmission function.

Preferably, the network identification code comprises a MAC address, and the network name comprises a SSID.

Preferably, the connection establishing program generates the password by encrypted with WPA or WPA2.

An exemplary embodiment of the present disclosure provides a method of establishing connection, adapted for an electronic device connecting with a wireless access point device by automatic pairing. The method comprises steps of: connecting to the wireless access point device from the electronic device; transmitting a network identification code from the electronic device to the wireless access point device; at the wireless access point device, generating a copy of the network identification code and a network name and a password, or generating a recognition pattern related to the network name and the password; at electronic device, receiving a network name and a password transmitted from the wireless access point device, or detecting the recognition pattern for obtaining the network name and the password; terminating the connection between the wireless access point device and the electronic device; transmitting a connection request containing the network identification code, the network name, and the password from the electronic device to the wireless access point device; establishing a connection between the electronic device and the wireless access point device when the connection request comprises the network name and the password, and the network identification code is equal to the copy of the network identification code.

Preferably, the network identification code comprises a MAC address.

An exemplary embodiment of the present disclosure provides a wireless access point device, adapted for connecting to an electronic device by automatic pairing. The wireless access point device comprises a temporary name and password generating unit, a connection unit, and a comparison unit. The temporary name and password generating unit generates a network name and a password. The connection unit transmits the network name and the password to the electronic device, or receives a network identification code or a connection request from the electronic device, and generates a copy of the network identification code. The connection request contains the network name, the password and the network identification code. The comparison unit determines whether the electronic device is permitted to log in the wireless access point device, according to the network name and the password of the connection request. When the network identification code of the connection request is equal to the copy of the network identification code, the comparison unit permits the wireless access point device to establish the connection between the electronic device and the wireless access point device.

Preferably, the wireless access point device comprises a cell phone, a camera, a laptop computer, a game player, a printer or a music player which have network transmission function.

Preferably, the temporary name and the password generating unit generates the network name or the password randomly, or generates the password by encrypted with WPA or WPA2.

An exemplary embodiment of the present disclosure provides a wireless access point device, adapted for connecting to an electronic device quickly. The wireless access point device comprises a name and password generating unit, a pattern generating unit, a display unit, and a connection processing unit. The name and password generating unit generates a network name and a password. The pattern generating unit encodes the network name and the password to be a recognition pattern. The display unit includes a display interface to display the recognition pattern. The connection processing unit receives a connection request from the electronic device, and permits the electronic device to connect with the wireless access point device according to the network name and the password of the connection request.

Preferably, the recognition pattern includes a QR code or a preset encoded picture.

Preferably, the recognition pattern or connection request further comprises a company name or a security type.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1A is a first schematic view of an exemplary embodiment of a wireless automatic pairing method according to the present disclosure.

FIG. 1B is a second schematic view of the exemplary embodiment of the wireless automatic pairing method according to the present disclosure.

FIG. 1C is a third schematic view of the exemplary embodiment of the wireless automatic pairing method according to the present disclosure.

FIG. 2 is a schematic view of another exemplary embodiment of the wireless automatic pairing method according to the present disclosure.

FIG. 3 is a flow diagram of another exemplary embodiment of the wireless automatic pairing method according to the present disclosure.

FIG. 4 is a flow diagram of still another exemplary embodiment of the method of establishing connection according to the present disclosure.

FIG. 5 is a block diagram of an embodiment of a wireless access point device according to the present disclosure.

FIG. 6 is a schematic view of the embodiment of the wireless access point device according to the present disclosure.

FIG. 7A is a first schematic view of another exemplary embodiment of a method of establishing connection according to the present disclosure.

FIG. 7B is a second schematic view of another exemplary embodiment of the method of establishing connection according to the present disclosure.

FIG. 7C is a third schematic view of another exemplary embodiment of the method of establishing connection according to the present disclosure.

FIG. 8 is a schematic view of an exemplary embodiment of the method of establishing connection according to the present disclosure.

FIG. 9 is a flow diagram of another exemplary embodiment of the method of establishing connection according to the present disclosure.

FIG. 10 is a block diagram of an eighth exemplary embodiment of a wireless access point device according to the present disclosure.

FIG. 11 is a schematic view of an exemplary embodiment of the method of establishing connection according to the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

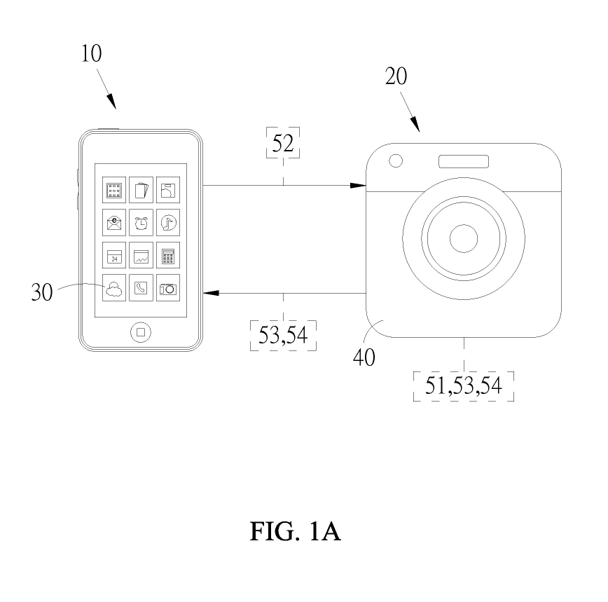

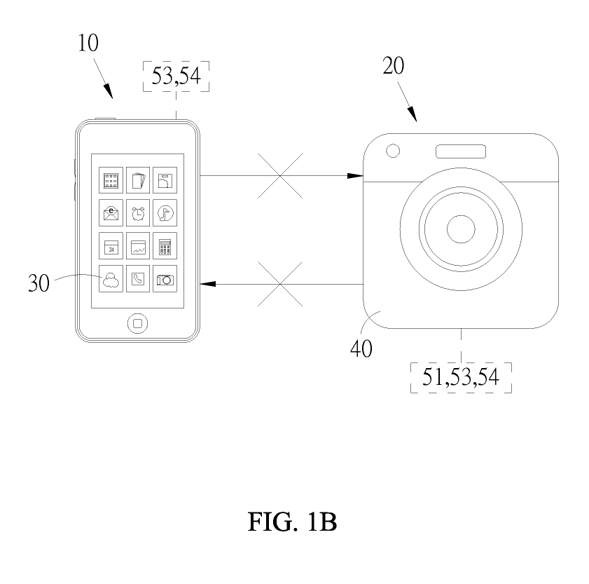

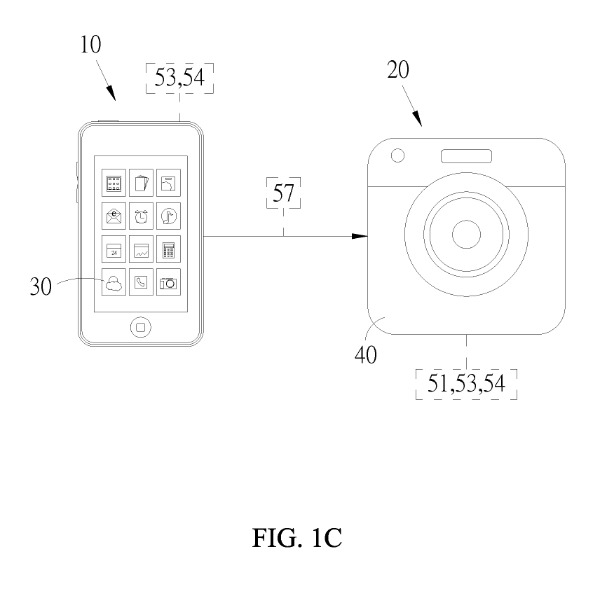

Please refer to FIG. 1A, FIG. 1B and FIG. 1C which are first schematic view, second schematic view and third schematic view of an exemplary embodiment of a wireless automatic pairing method according to the present disclosure. As shown in FIG. 1A, the user can install a connection establishing program 30 in an electronic device 10, and uses the connection establishing program 30 to connect with a connection service program 40 of the wireless access point device 20 for connecting to internet.

In this exemplary embodiment, a smart phone and a camera with network transmission function are taken as examples of the electronic device 10 and the wireless access point device 20, respectively. The camera can serve as a hotspot, and the smart phone can connect to internet via this hotspot, but the present disclosure is not limited thereto. For example, the electronic device 10 further includes a computer or a tablet computer with Wi-Fi connection function. The connection establishing program 30 can a cell phone application or a computer application. The wireless access point device 20 can include a cell phone, a laptop computer, a game player, a printer, or a MP3 player which have network transmission function. The connection service program 40 can be a server application for listening packet data from the wireless network.

Before the wireless access point device 20 and the connection establishing program 30 communicate for connection, the wireless access point device 20 is set in an open mode, so the wireless access point device 20 permits any electronic device 10 to use SSID of the wireless access point device for connection. The SSID is an abbreviation of the service set identifier. In other words, when the connection establishing program 30 is installed in the electronic device 10 and is being executed, the connection establishing program 30 can search a SSID, such as MyAP_{—}1, of the wireless access point device 20 via Wi-Fi, and the connection service program 40 of the wireless access point device 20 is used to obtain a network packet transmitted from the electronic device 10, and extract a source MAC address from a header field of the network packet, which is a network identification code 52 of the electronic device 10. In addition, the data in the network packet can also include connection data related to the connection establishing program 30, such as a unique identification code of the connection establishing program 30, so that the connection service program 40 can identify whether the network packet is transmitted from the connection establishing program 30.

When the connection service program 40 determines that the connection data is sent by the connection establishing program 30, the connection service program 40 generates a network name 53 and a password 54 randomly, and generates a copy 51 of the network identification code according to the network identification code 52. Next, the connection service program 40 transmits the network name 53 and the password 54 to the connection establishing program 30 of the electronic device 10. In implementation, the connection service program 40 can generate the password 54 by encrypted with WPA or WPA2.

In implementation, after transmitting the network name 53 and the password 54, the connection service program 40 closes the open mode automatically and set the wireless access point device 20 to be an encryption mode, it means that the electronic device 10 must use the network name 53 and the password 54 to log in the wireless access point device 20.

As shown in FIG. 1B, after receiving the network name 53 and the password 54, the connection establishing program 30 terminates the previous connection with the connection service program 40. As shown in FIG. 1C, the connection establishing program 30 transmits a connection request 57 to the connection service program 40 via Wi-Fi, and the connection request 57 includes data of the network name 53, the password 54 and the network identification code 52. By the network name 53 and the password 54 of the connection request 57, the electronic device 10 can log in the wireless access point device 20.

According to the network identification code 52 in the connection request 57, the connection service program 40 determines whether the connection establishing program 30 can establish the connection between the electronic device 10 and the wireless access point device 20 via the wireless access point device 20. The determination way is to compare the network identification code 52 with the copy 51 of the network identification code. If the copy 51 matches the network identification code 52, the connection establishing program 30 is permitted to establish the connection between the electronic device 10 and the wireless access point device 20 via the wireless access point device 20.

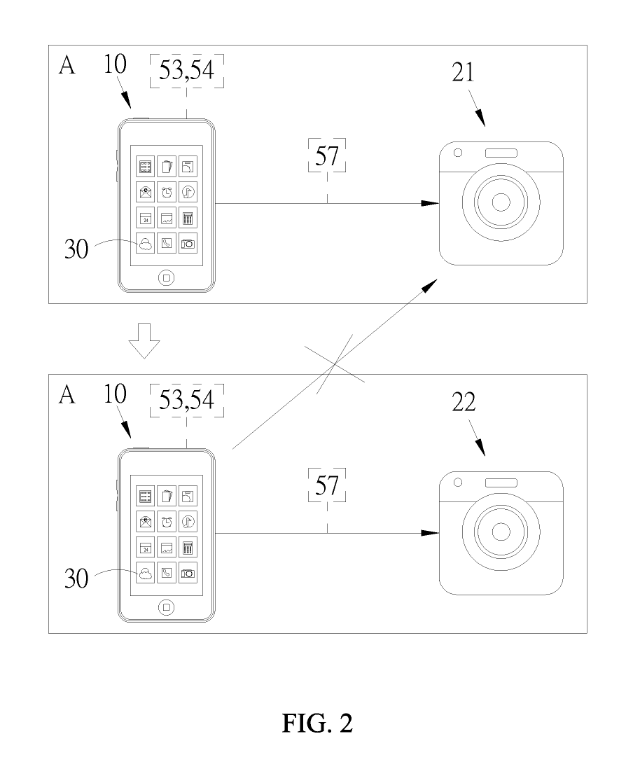

Please refer to FIG. 2 which is a schematic view of another exemplary embodiment of the wireless automatic pairing method according to the present disclosure. When the electronic device 10 leaves the internet area A provided by the first wireless access point device 21, as long as the electronic device 10 moves to the internet area B provided by a second wireless access point device 22 and executes the connection establishing program 30 installed therein, the connection establishing program 30 can perform automatic pairing with the connection service program 40 of the second wireless access point device 22, whereby the electronic device 10 can connect to internet via the second wireless access point device 22. The way of automatic pairing is the same as the way shown in FIG. 1A˜FIG. 1C, so the detailed description is omitted.

By the way of automatic pairing, the user need not manually input the password 54 for the wireless access point device 20, and just executes the connection establishing program 30 in the electronic device 10 to connect to internet by connecting to the wireless access point device 20 via Wi-Fi. Even though the electronic device 10 leaves the accessible range of a wireless access point device 20, and moves to the accessible range of other wireless access point device 20, it is easy for the user to connect to internet by executing the connection establishing program 30.

On the other hand, because the network name 53 and the password 54 generated by the connection service program 40 is generated randomly according to each connection request of the connection establishing program 30, the connection service program 40 can be set that the connection service program 40 does not permit the connection establishing program 30 to perform connection via the wireless access point device 20 until the period between receipt of connection data and the connection request 57 lower than a threshold, such as 500 ms. Therefore, it can make sure that the connection data and the connection request 57 are sent by the same electronic device 10.

Therefore, apart from the password 54 being stolen by the person with high aspirations and determination, this way of automatic pairing can omit the behavior that the wireless access point device 20 changes the password 54 every period of time, so the convenience and security for the user is improved efficiently.

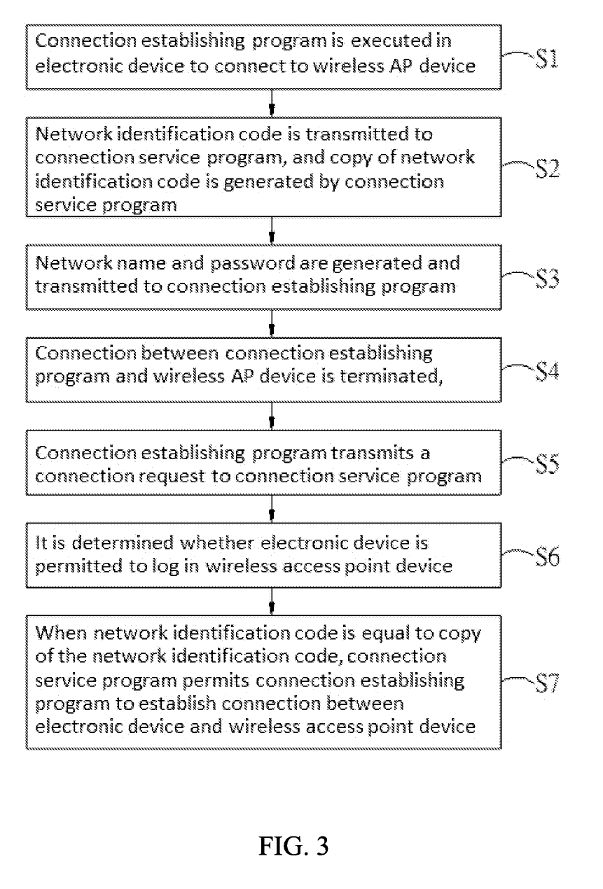

Please refer to FIG. 3 which is a flow diagram of the wireless automatic pairing method according to afore-mentioned embodiments of the present disclosure. In step S1, a connection establishing program is executed in an electronic device to connect to the wireless access point device. In step S2, a network identification code of the electronic device is transmitted to a connection service program of the wireless access point device, and a copy of the network identification code of the network identification code is generated by the connection service program. In step S3, a network name and a password are generated by the connection service program and transmitted to the connection establishing program.

In step S1˜step S3, as shown in FIG. 1A, the connection establishing program 30 is executed to search a SSID corresponding to the wireless access point device 20 on the network, and the connection establishing program 30 transmits a MAC address to the connection service program 40 and receives the network name 53 and the password 54 generated by the connection service program 40. In step S4, the connection between the connection establishing program and the wireless access point device is terminated, as shown in FIG. 1B.

In step S5, the connection establishing program is used to transmit a connection request to the connection service program 40. The connection request contains the network name and the password. In step S6, it is determined whether the electronic device is permitted to log in the wireless access point device according to the network name and the password of the connection request. In step S7, when the network identification code is equal to the copy of the network identification code, the connection service program permits the connection establishing program to establish the connection between the electronic device and the wireless access point device, via the wireless access point device. In the step S5˜step S7, as shown in FIG. 1C, the connection establishing program 30 transmits the connection request 57 to the connection service program 40 to ask for establishing the connection between the electronic device 10 and the wireless access point device 20, via the wireless access point device 20.

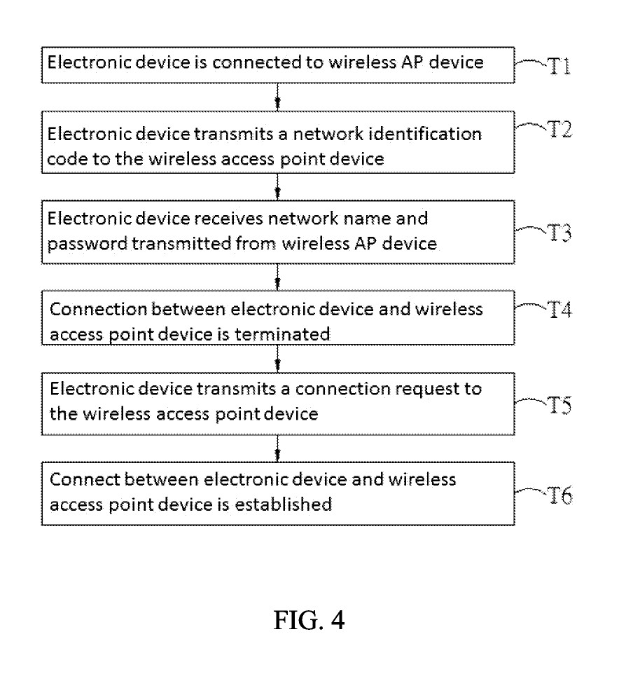

Please refer to FIG. 4 which is a flow diagram of still another exemplary embodiment of the method of establishing connection according to the present disclosure. The method is adapted for an electronic device to connect with a wireless access point device by automatic pairing, and includes following steps. In step T1, the electronic device is connected to the wireless access point device. In step T2, the electronic device transmits a network identification code to the wireless access point device. In step T3, the electronic device receives a network name and a password transmitted from the wireless access point device. In step T4, the connection between the electronic device and the wireless access point device is terminated. In step T5, the electronic device transmits a connection request to the wireless access point device, and the connection request contains the network identification code, the network name and the password. In step T6, the connection between the electronic device and the wireless access point device is established via the wireless access point device.

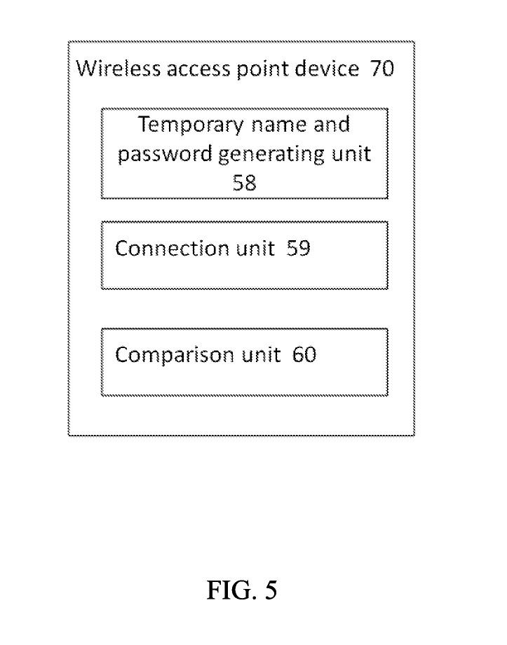

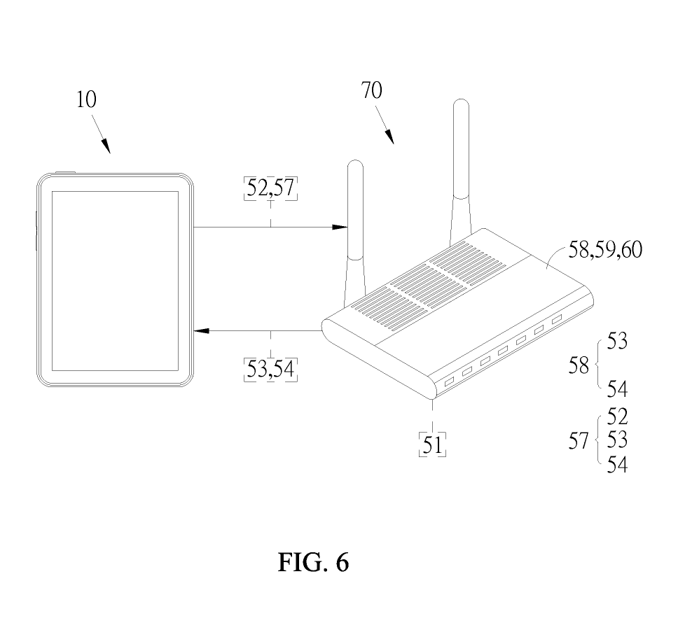

Please refer to FIG. 5 and FIG. 6 which are block diagram and schematic view of an embodiment of a wireless access point device according to the present disclosure. The wireless access point device 70 is adapted for connecting to an electronic device 10 by automatic pairing. In this exemplary embodiment, a tablet computer and a wireless router are taken as examples for the electronic device 10 and the wireless access point device 70, respectively, but the present disclosure is not limited thereto. The electronic device 10 can also include a computer or a smart phone with Wi-Fi connection function. The wireless access point device 20 can include a cell phone, a camera, a laptop computer, a game player, a printer or a MP3 player which have network transmission function.

The wireless access point device 70 includes a temporary name and password generating unit 58, a connection unit 59, and a comparison unit 60. The temporary name and password generating unit 58 can generate the network name 53 and the password 54 randomly. The connection unit 59 transmits the network name 53 and the password 54 to the electronic device 10 or receives the network identification code 52 or the connection request 57 from the electronic device 10, and generates the copy 51 of the network identification code 52. The connection request 57 contains the network name 53, the password 54 and the network identification code 52. The comparison unit 60 determines whether the electronic device 10 is permitted to log in the wireless access point device 70 according to the network name 53 and the password 54 of the connection request 57. When the network identification code 52 of the connection request 57 is equal to the copy 51, the comparison unit 60 permits the wireless access point device 70 to establish the connection between the electronic device 10 and the wireless access point device 70. In implementation, the temporary name and password generating unit 58, the connection unit 59 and the comparison unit 60 can be a software application or a sub-function called by the connection service program 40 shown in the FIG. 1A to the FIG. 1C, and the detailed connection steps are the same as the steps shown in the FIG. 1A to FIG. 1C, so the description is omitted.

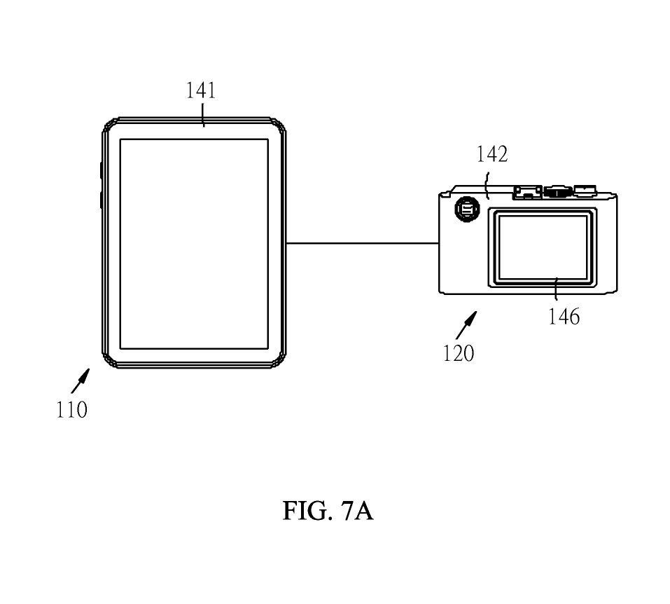

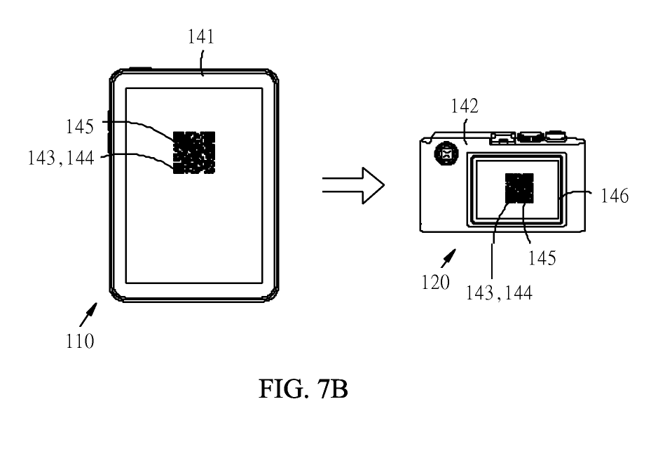

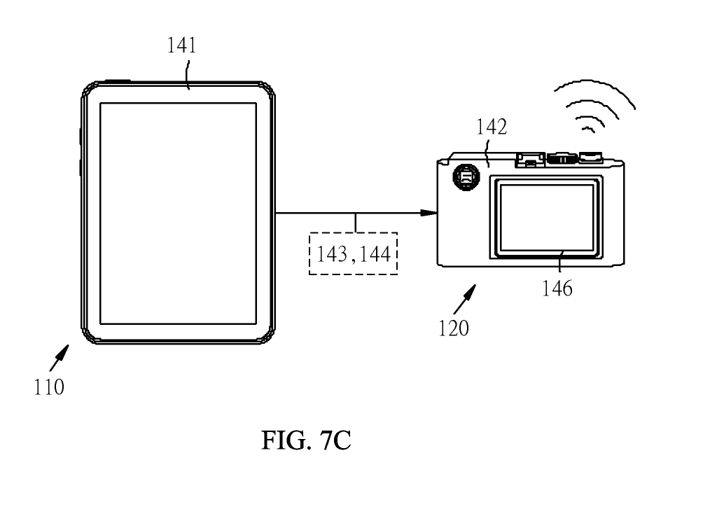

Please refer to FIG. 7A, FIG. 7B and FIG. 7C which are first schematic view, second schematic view and third schematic view of another exemplary embodiment of a method of establishing connection according to the present disclosure. In this exemplary embodiment, a tablet computer and a camera having network transmission function are taken as examples for the electronic device 110 and the wireless access point device 120, respectively, but the present disclosure is not limited thereto. The electronic device 110 can include a computer or a smart phone with lens. The wireless access point device 120 can include a cell phone, a camera, a laptop computer, a game player, a printer, or music player which has network transmission function. In this exemplary embodiment, the wireless access point device 120 is set in an open mode for the network, and it is a non-encryption status.

As shown in FIG. 7A, a service program 142 is installed in the wireless access point device 120 and is executed, and a connection establishing program 141 is installed in the electronic device 110. The wireless access point device 120 can serve as a server end, and the electronic device 110 can serve as a user end. The connection establishing program 141 and the service program 142 are socket applications of the user end and the server end, respectively. After being executed, the service program 142 starts to wait for a connection request of the connection establishing program 141, so when the user executes the connection establishing program 141, the connection establishing program 141 and the service program 142 can establish a connection via Wi-Fi.

As shown in FIG. 7B and FIG. 7C, after the connection is established, the service program 142 generates a network name 143 and a password 144 randomly, and encode the network name 143 and the password 144 in a recognition pattern 145. The network name 143 can include a SSID, and the recognition pattern 145 can include a QR-code or a preset encoded picture. The recognition pattern 145 is shown on a display interface 146 of the wireless access point device 120. The display interface 146 can be a LCD screen or a LED screen. In addition, after generating the recognition pattern 145, the wireless access point device 120 terminates the connection with the electronic device 110.

The user can use the lens of the electronic device 110 to scan the recognition pattern 145, so as to obtain the network name 143 and the password 144. The connection establishing program 141 then transmits the network name 143 and the password 144 to the wireless access point device 120. After the service program 142 of the wireless access point device 120 receives the information, it means that the electronic device 110 is permitted to log in the wireless access point device 120 and establish the connection between the electronic device 110 and the wireless access point device 120, whereby the electronic device 110 can connect to internet via the wireless access point device 120.

For detailed illustration, the method of establishing connection of the present disclosure can increase or change the data in the recognition pattern 145 upon demand. For example, the recognition pattern 145 can further include a company name, a security type, a MAC address of the network card, a time period permitting to login, or a key. The electronic device 110 installed with the connection establishing program 141 can receive the data and log in the wireless access point device 120 according to the data. Therefore, the security scheme for the wireless access point device 120 can be improved efficiently, and it can prevent the wireless access point device 120 from being logged in by illegal electronic device 110.

In addition, the recognition pattern 145 can be a preset encoded picture (not shown in FIGs), and the data format within the preset encoded picture is determined while the recognition pattern 145 is generated. The data format can be contained the network packet transmitted to the connection establishing program 141 by the service program 142, and the definition of the data format only be known by the connection establishing program 141 and the service program 142, so the security of connection establishing way of logging in the wireless access point device 120 can be improved efficiently. For example, in the network packet transmitted to the connection establishing program 141, the header is used to define the length and position of the data in the payload data, and the connection establishing program 141 must parse the data of the header to extract the correct network name 143 and password 144 from the payload data.

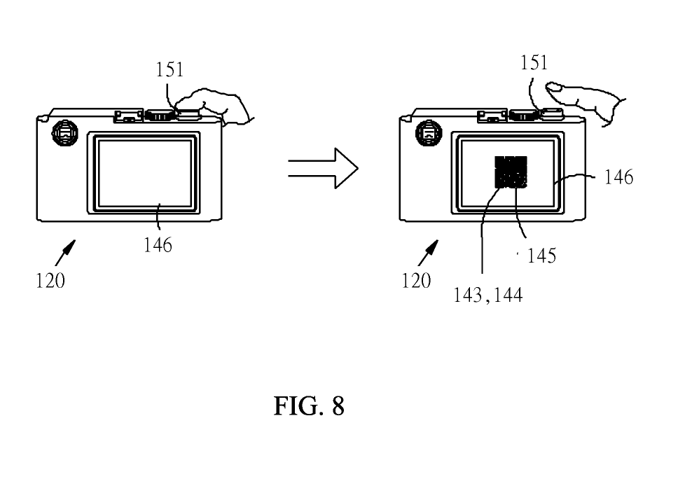

Please refer to FIG. 8 which is a schematic view of a sixth exemplary embodiment of the method of establishing connection according to the present disclosure. Compared with the exemplary embodiment in FIG. 7A to FIG. 7C where the connection between the electronic device 110 and the wireless access point device 120 is established in open mode first and then the wireless access point device 120 generates the recognition pattern 145, In this exemplary embodiment the wireless access point device 120 generates a recognition pattern 145 containing the network name 143 and the password 144 and displays the recognition pattern 145 on the display interface 146 of the wireless access point device 120 before the connection between the electronic device 110 and the wireless access point device 120 is established. For example, the recognition pattern 145 can be generated by pressing a function button of the wireless access point device 120. For example, in the exemplary embodiment shown in FIG. 8, the shutter release button 151 of the wireless access point device 120 serves as the function button for generating the recognition pattern 145. When the shutter release button 151 is pressed for three seconds, it is a control signal to trigger the generation of the recognition pattern 145, and the generated recognition pattern 145 is directly shown on the display interface 146 after the shutter release button 151 is released. The recognition pattern 145 contains the network name 143 and the password 144. Therefore, the wireless access point device 120 can directly provide the user to generate the recognition pattern 145 on the wireless access point device 120 without adding any extra members or control manner.

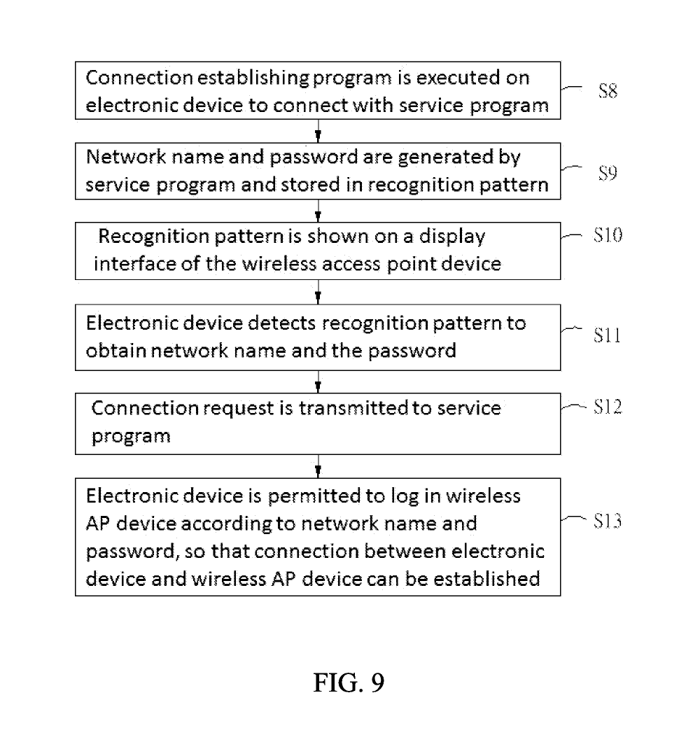

Please refer to FIG. 9 which is a flow diagram of another exemplary embodiment of the method of establishing connection according to the present disclosure. In step S8, a connection establishing program is executed on an electronic device to connect with a service program of a wireless access point device, the connection way is the same as the content shown in FIG. 7A. In step S9, a network name and a password are generated by the service program and stored in a recognition pattern. In step S10, the recognition pattern is shown on a display interface of the wireless access point device. In step S11, the electronic device is used to detect the recognition pattern shown on the display interface, to obtain the network name and the password. The executions for the step S9 to S11 is the same as the content shown in FIG. 7B, the lens of the electronic device 110 is used to scan the display interface 146 of the wireless access point device 120, to obtain the network name 143 and the password 144. In step S12, a connection request including the network name and the password is transmitted to the service program. In step S13, the electronic device is permitted to log in the wireless access point device according to the network name and the password of the connection request, so that the connection between the electronic device and the wireless access point device can be established. The execution for the step 12 to the step 13 is the same as the content shown in FIG. 7C, the service program 142 permits the electronic device 110 to log in the wireless access point device 120 according to the network name 143 and the password 144 transmitted from the electronic device 110.

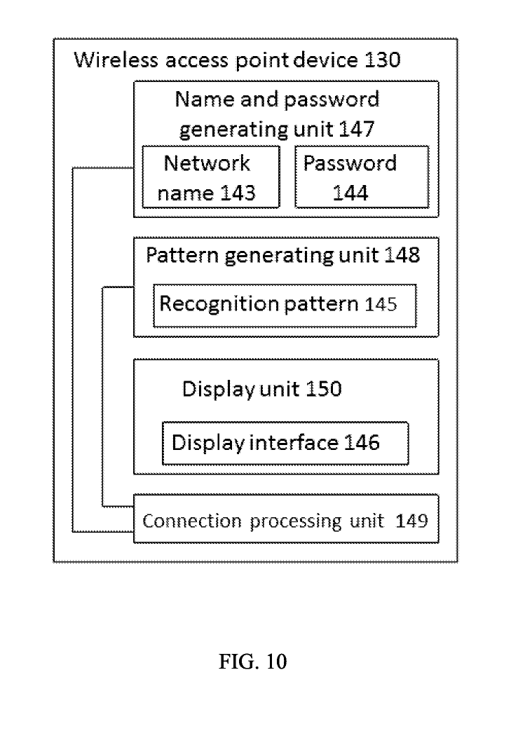

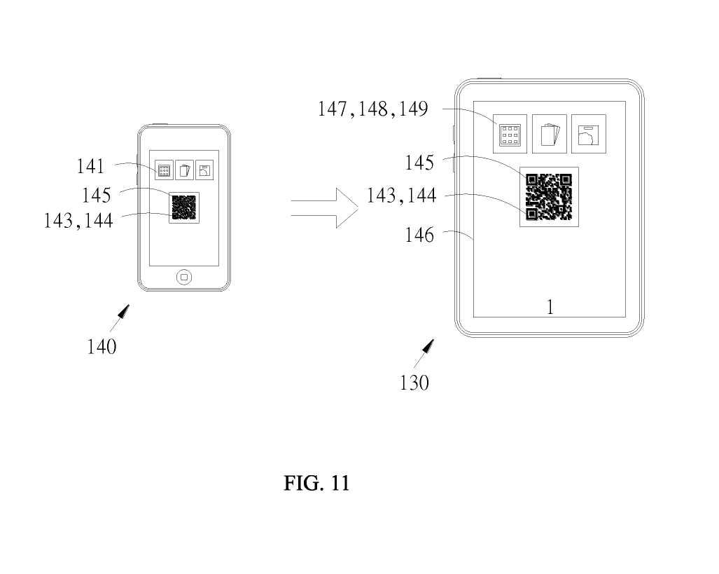

Please refer to FIG. 10 which is a block diagram of an exemplary embodiment of a wireless access point device according to the present disclosure. Please refer to FIG. 11 which is a schematic view of a ninth exemplary embodiment of the method of establishing connection according to the present disclosure. As shown in FIG. 10, the wireless access point device 130 of this exemplary embodiment is adapted for quickly connecting to an electronic device 140. The wireless access point device 130 includes a name and password generating unit 147, a pattern generating unit 148, a display unit 150 and a connection processing unit 149. In this exemplary embodiment, a tablet computer and a smart phone are taken as the examples of the wireless access point device 130 and the electronic device 140, respectively, but the present disclosure is not limited thereto. The display unit 150 includes a LCD screen or a LED screen. The name and password generating unit 147, the pattern generating unit 148, and the connection processing unit 149 are software applications, respectively.

When the wireless access point device 130 is in an open mode, a connection establishing program 141 of the electronic device 140 can connect to the wireless access point device 130 under non-encryption connection status. The name and password generating unit 147 of the wireless access point device 130 generates a network name 143 and a password 144. Alternatively, the user can activate the name and password generating unit 147 of the wireless access point device 130 in the non-connected status, to generate the network name 143 and the password 144. The pattern generating unit 148 can encode the network name 143 and the password 144 to generate a recognition pattern 145. The display unit 150 includes a display interface 146 to show the recognition pattern 145. The display interface 146 can be a screen. The connection processing unit 149 receives a connection request from the electronic device 140 and permits the electronic device 140 to log in with the wireless access point device 130 according to the network name 143 and the password 144 of the connection request.

Preferably, the recognition pattern 145 can be a QR-code or a preset encoded picture, and the position of the network name 143 or the password 144 in the preset encoded picture can be determined while the electronic device 140 is connected to the wireless access point device 130. The name and password generating unit 147 can generate the network name 143 or the password 144 randomly. The recognition pattern 145 further includes information of a company name or a security type. The detailed content about the quick connection between the wireless access point device 130 and the electronic device 140 is the same as the FIG. 7A˜FIG. 7C, so the description is omitted.

In summary, the wireless automatic pairing method, the method of establishing connection and the wireless access point device of the present disclosure can provide the user to input one-time password without manual operation, so that the electronic device can automatically connect to a wireless access point device under an encryption mode, and the convenience for user operation and security of data transmission can be improved. Moreover, via the connection service program and the connection establishing program, the wireless access point device can verify the electronic device by MAC address or the interval of response time, so the present disclosure can provide the method of automatic pairing with security.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A wireless automatic pairing method, adapted for a wireless connection between an electronic device and a wireless access point device, the method comprising:
executing a connection establishing program on the electronic device to connect with the wireless access point device;
transmitting a network identification code of the electronic device to a connection service program of the wireless access point device, and generating a copy of the network identification code;
using the connection service program of the wireless access point device to generate and transmit a network name and a password to the connection establishing program, or using the electronic device to detect a recognition pattern for obtaining the network name and the password, the recognition pattern being generated by the connection service program;
terminating the connection between the wireless access point device and the electronic device;
using the connection establishing program to transmit a connection request to the connection service program, the connection request containing the network name and the password, and the network identification code; and
determining whether the network identification code, the network name, the password is correct or not;
wherein when the connection request comprises the network name and the password, and the network identification code is equal to the copy of the network identification code, the connection service program permits the connection establishing program to establish the connection between the wireless access point device and the electronic device.

2. The method as defined in claim 1, wherein the wireless access point device is preset in an open mode, after the connection service program transmits the network name and the password to the connection establishing program, the connection service program sets the wireless access point device in an encryption mode.

3. The method as defined in claim 1, wherein the recognition pattern is displayed on a display interface of the wireless access point, and the electronic device detects the display interface of the recognition pattern to obtain the network name and the password.

4. The method as defined in claim 3, wherein the recognition pattern includes a QR code or a preset encoded picture.

5. The method as defined in claim 4, wherein the recognition pattern further comprises a company name or a security type.

6. The method as defined in claim 5, further comprising a step of using the connection establishing program to connect with the wireless access point device while the electronic device and the wireless access point device are connected, to enable the wireless access point device to generate the network name and the password, wherein a position of the password in the recognition pattern is determined while the connection establishing program is connected with the wireless access point device.

7. The method as defined in claim 1, wherein the wireless access point device comprises a cell phone, a camera, a laptop computer, a game player, a printer or a music player which have network transmission function.

8. The method as defined in claim 1, wherein the network identification code comprises a MAC address and the network name comprises a SSID.

9. The method as defined in claim 1, wherein the connection establishing program generates the password by encrypted with WPA or WPA2.

10. A wireless access point device, adapted for connecting to an electronic device by automatic pairing, and the wireless access point device comprising:
a temporary name and password generating unit, configured for generating a network name and a password;
a connection unit, configured for transmitting the network name and the password to the electronic device, or receiving a network identification code or a connection request from the electronic device, and generating a copy of the network identification code, the connection request containing the network name, the password and the network identification code; and
a comparison unit, configured for determining whether the electronic device is permitted to log in the wireless access point device, according to the network name and the password of the connection request, wherein when the network identification code of the connection request is equal to the copy of the network identification code, the comparison unit permits the wireless access point device to establish the connection between the electronic device and the wireless access point device.

11. The wireless access point device as defined in claim 10, wherein the wireless access point device comprises a cell phone, a camera, a laptop computer, a game player, a printer or a music player which have network transmission function.

12. The wireless access point device as defined in claim 10, wherein the temporary name and password generating unit generates the network name or the password randomly, or generates the password by encrypted with WPA or WPA2.

13. A wireless access point device, adapted for quickly connecting to an electronic device, and the wireless access point device comprising:
a name and password generating unit, configured for generating a network name and a password;
a pattern generating unit, configured for encoding the network name and the password to be a recognition pattern;
a display unit, including a display interface to display the recognition pattern; and
a connection processing unit, configured for receiving a connection request from the electronic device, and permitting the electronic device to connect with the wireless access point device according to the network name and the password of the connection request.

14. The wireless access point device as defined in claim 13, wherein the recognition pattern includes a QR code or a preset encoded picture.

15. The wireless access point device as defined in claim 14, wherein the recognition pattern or the connection request further comprises a company name or a security type.
